(19) United States
(12) Patent Application Publication
(10) Pub. No.: US 2008/0243763 A1
(43) Pub. Date: Oct. 2, 2008

(54) SYSTEM, METHOD AND PROGRAM TO PROVIDE DATA TO ANOTHER PROGRAM

(75) Inventors: Ellis E. Bishop, Austin, TX (US); Michael J. Spisak, East Northport, NY (US)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/691,561

(22) Filed: Mar. 27, 2007

(51) Int. Cl. G06F 17/30

(52) U.S. Cl. 707/2

(57) ABSTRACT

System, method and program product for providing data to a program for processing. An electronic spreadsheet is formed. One or more cells in the spreadsheet are mapped to the program. Based on the mapping, one or more data entries in the one or more cells, respectively are automatically forwarded to the program for processing. The data entries can be forwarded in data objects. Alternately, a list of data objects available for export are published. The data objects include respective data entries from respective cells in an electronic spreadsheet. In response to the program requesting one or more of the data objects, the one or more data objects are forwarded to the program for processing.

### FIELD OF THE INVENTION

The present invention relates generally to computer systems and programs, and more specifically to provision of data to an application program or web service program.

### BACKGROUND OF THE INVENTION

Computer programs, such as application programs and web service programs, typically process data. For example, a known software installation program receives data specifying what software to install in a target server, as well as an identity and description of the target server. With this data, the software installation program can automatically fetch the software from a repository and install the software in the target server. While the foregoing technique is effective, it requires an administrator to enter the data using the Application Program Interface (“API”) of the software installation program. Typically, administrators are responsible for administering many different programs, and it may be difficult for them to remember the API of each and every type of program. Also, people with less technical knowledge than an administrator may not be familiar with the API of each program.

Electronic spreadsheet programs such as Lotus 1-2-3 spreadsheet program and Excel spreadsheet program are well known today. An electronic spreadsheet is an electronically generated and stored table with columns, rows, column headings and data entries in the cells of the table. (Each “cell” is a field at the intersection of a column and row of the table.) The rows can be numbered or contain row headings. The data entries in the cells can be data values. It was also known to include a formula in a cell where the formula generates a data value based on other data entries in the table. It was also known to include a hyper link as an entry in a cell in the table. Consequently, if a user “clicks” on the hyper link, the user's web browser will fetch and display the corresponding web page. It was also known to automatically transfer data entries from spreadsheet cells to a backend database. For example, it was known to link a spreadsheet to a database using ODBC (Open Database Connectivity) or OLAP (On Line Analytical Processing) technologies to store and retrieve data.

An object of the present invention is to facilitate provisioning of data to a program such as an application program or web service program.

### SUMMARY OF THE INVENTION

The present invention resides in a system, method and program product for providing data to a program for processing. One or more cells in an electronic spreadsheet are mapped to the program. Based on the mapping, one or more data entries in the one or more cells, respectively are automatically forwarded to the program for processing. The data entries can be forwarded in data objects.

The present invention also resides in another system, method and program product for providing data to a program for processing. A list of data objects available for export are published. The data objects include respective data entries from respective cells in an electronic spreadsheet. In response to the program requesting one or more of the data objects, the one or more data objects are forwarded to the program for processing.

### BRIEF DESCRIPTION OF THE FIGURES

FIG. 1 is a block diagram of a distributed computer system comprising a server computer and a client computer which include the present invention.

FIG. 2 is a flow chart of a function within a spreadsheet management program within the server of FIG. 1 to initiate formation of a functional spreadsheet.

FIG. 3(A) is a flow chart of a function within the spreadsheet management program in the server of FIG. 1 to furnish a latest copy of the functional spreadsheet to a source spreadsheet in the client computer for editing by a user with a known spreadsheet generation program.

FIG. 3(B) is a flow chart of a function within the spreadsheet management program within the server of FIG. 1 to enable a user to edit the source spreadsheet in the client computer and furnish the updated version of the source spreadsheet to the server to replace the prior version of the functional spreadsheet.

FIG. 4 is a flow chart of a function within the spreadsheet management program of FIG. 1 to define and publish the definitions of exportable objects comprising respective data entries within the functional spreadsheet.

FIG. 5 is a flow chart of a function within the spreadsheet management program of FIG. 1 to furnish an object that has been published to and requested by a data processing program.

FIG. 6 is a flow chart of a function within the spreadsheet management program of FIG. 1 to “push” an object (which may or may be published) comprising a data entry from the functional spreadsheet to a data processing program.

### DETAILED DESCRIPTION OF THE PREFERRED EMBODIMENTS

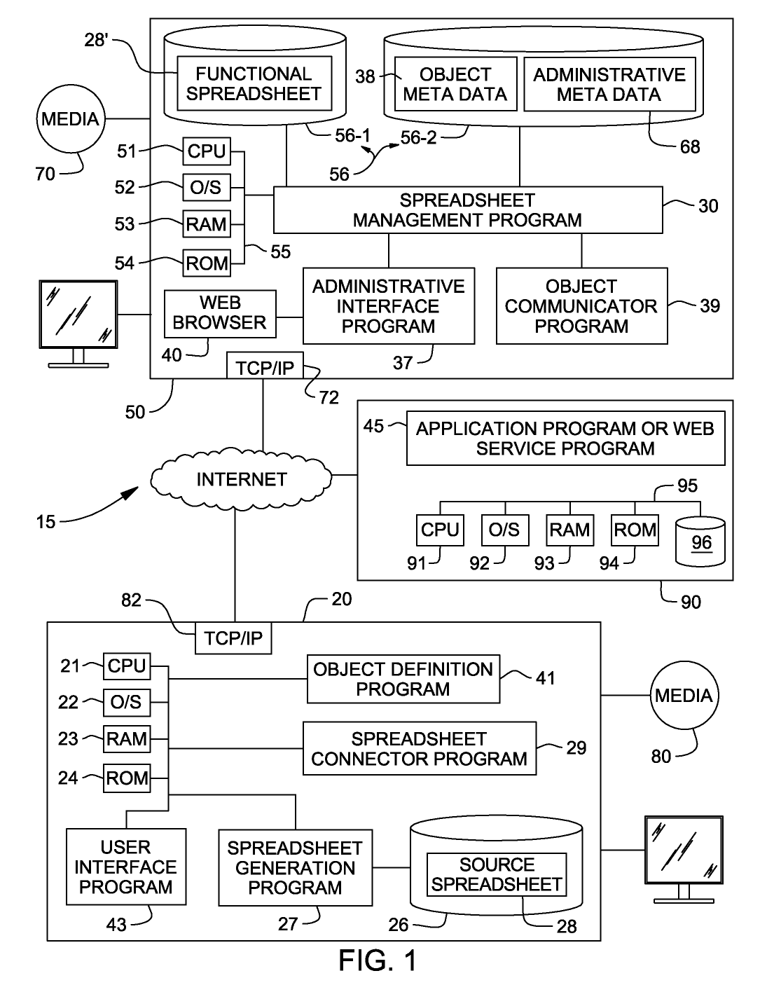

The present invention will now be described in detail with reference to the figures. FIG. 1 illustrates a distributed computer system generally designated 15 which includes the present invention. Distributed computer system 15 comprises a client workstation 20 and a server computer 50. Client workstation 20 can comprise a personal computer, laptop, or any computer that may execute a spreadsheet application. Client workstation 20 includes a CPU 21, operating system 22, RAM 23 and ROM 24 on a common bus 25 and storage 26 according to the prior art. Server 50 includes a CPU 51, operating system 52, RAM 53 and ROM 54 on a common bus 55 and storage 56 according to the prior art. (However, if desired, a single computer can substitute for both the client workstation 20 and server computer 50, and execute all the programs and include all the databases contained in workstation 20 and server 50.) Workstation 20 also includes a known spreadsheet generation program 27 such as Lotus 1-2-3 spreadsheet generation program or Excel spreadsheet generation program, according to the prior art. The known spreadsheet generation program 27 provides a table template with columns and rows forming cells, and enables a user to enter data into the cells and headings for the columns and rows. Each “cell” is a field in at the intersection of a specific column and row of the table. Typically, the user will enter a heading for each column, in addition to the data entries. The rows can be numbered or contain row headings in the leftmost column. Each data entry can be a data value or a formula. A formula is an equation or description of the data that corresponds to the cell. For example, a formula may specify that the data entries from two other cells are joined together to form the data entry for the cell specified by formula. By way of example, the data entries in the form of data values can be a server name, server IP address, amount of RAM, amount of storage, location, requisite software, etc. of a server to be built. In such a case the spreadsheet can be called a “build sheet”. As another example, the data entries in the spreadsheet can be a building location where servers are kept, a server rack number, network plug identifier, network segment identifier, etc. In such a case, the spreadsheet can be called a “physical network data sheet”. As another example, the data entries in the spreadsheet can be a listing of products to be sold to a customer, associated prices, materials, tasks, tooling, etc. In such a case, the spreadsheet can be called a “cost model”. With program 27, a user generates a populated, source spreadsheet 28 in the known manner.

According to the present invention, a user specifies to an object definition program 41 within workstation 20 the spreadsheet cells from which respective data entries can be sent to another program such as an application program, web service program, data interchange program, or other application program with an exposed programming interface 45. Program 45 resides in an external computer 90 with a CPU 91, operating system 92, RAM 93 and ROM 94 on a common bus 95 and storage 96. In one mode of operation, the spreadsheet management program 30 publishes the objects which are available for other programs, and the other programs request or “pull” them when needed. In another embodiment of the present invention, the spreadsheet management program 30 “pushes” the objects to other, target programs specified by the user. In the latter case, along with defining the object, the user specifies what function or address within the target program should receive the object to process the respective data entry. After the pulling or pushing of the object, as the case may be, the other program that receives the object will process the respective data entry within the object. For example, a software installation program can use data entries/objects from a server build (spread) sheet to automatically install the software specified in the build sheet into the server specified in the build sheet to be built. As another example, an enterprise workflow program can use a data entry/object from a spreadsheet for the purpose of checking inventories in the context of a service order workflow. As another example, a statistical analysis program can use a data entry/object from a spreadsheet for the purpose of remotely executing a formula embedded within the spreadsheet as an API service call and calculate results using other data obtained from the spreadsheet. As another example, a work order approval process program can use a data entry/object from a spreadsheet for the purpose of initiating processes after specified cells within the spreadsheet are completed.

Workstation 20 also includes a spreadsheet connector program 29 which provides an interface between spreadsheet generation program 27 and spreadsheet management program 30. The functional spreadsheet 28′ (which corresponds to original spread sheet 28) is stored in a portion 56-1 of storage 56. A portion 56-2 of storage 56 includes administrative meta data 68 and object meta data 38. Object meta data 38 comprises specifications or instructions as to which data entries from the functional spreadsheet will be published and available to be “pulled” as objects and which data entries from the functional spreadsheet should be pushed as objects to which other programs. A key correlates functional spreadsheet 28′ to its object meta data 38. Administrative meta data 68 comprises a name of the functional spreadsheet 28′, informational descriptions of the functional spreadsheet 28, and access rights and credentials to the functional spreadsheet 28.

Server computer 50 also includes an administrative graphical interface program 37 to enable an administrator to interface to spreadsheet management program 30 and name and otherwise set up the functional spreadsheet 28′ based on the source spreadsheet 28. An administrator uses a web browser 40 in server 50 to access the administrative interface program 37.

Workstation 20 includes a user interface program 43 (for example, in a web browser environment) to enable a user to define the original spreadsheet 28 and specify the content of each data object, and in the case of pushing data objects, which other program and function in the other program 45 should receive the object.

Server 50 also includes an object communicator program 39 which publishes the object definitions in the case where the other programs “request/pull” them. The object communicator program 39 also sends the specified objects to other programs in the case where the spreadsheet management program “pushes” them. Object communicator program 39 uses a known protocol such as SOAP, WSDL, etc. protocol to communicate with the other programs 45. These other programs 45 can also execute on different computers. Object communicator program 39 also processes subscriptions by the other programs 45 to receive publication of the objects.

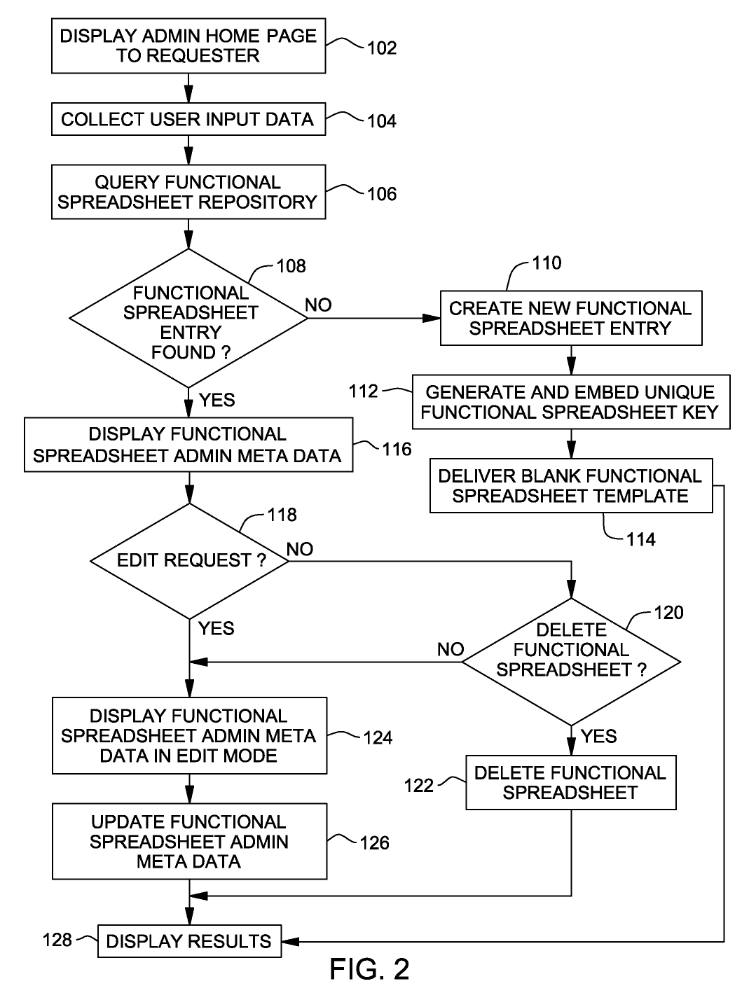

FIG. 2 is a flow chart of a function within spreadsheet management program 30 within server computer 50 to enable an administrator to initiate functional spreadsheet 28′ based on a source spreadsheet 28. An administrator logs-on to program 30 via web browser 40 and in response, administrator interface program 37 authenticates the administrator and displays a home page (step 102). Next, the administrator identifies (by name) functional spreadsheet 28′ to be administered (step 104). In response, program 30 attempts to locate and fetch pre-existing administrative data for functional spreadsheet 28′ (step 106). If administrative data for functional spreadsheet 28′ has not yet been created (decision 108, no branch), then program 30 queries the administrator to enter the following administrative data for the functional spreadsheet 28′: name of functional spreadsheet, access list, and functional description (step 110). Next, program 30 generates a unique key for the functional spreadsheet 28′ and includes the unique key in the administrative data 68 for the functional spreadsheet 28′ (step 112). Next, program 30 fetches and displays a blank spreadsheet template including a macro to enter data entries into the functional spreadsheet (step 114), and displays the administrative data (step 128).

Refer again to decision 108, yes branch, where an administrator previously defined administrative data for the functional spreadsheet 28′. In such a case, program 30 will fetch and display the functional spreadsheet 28′, display the name of the functional spreadsheet (step 116), and provide the administrator with an opportunity to edit the administrative meta data for the functional spreadsheet 28′ (step 118). If the administrator selects the “edit” option (decision 118, yes branch), then program 30 will display the spreadsheet administrative meta data in edit mode (step 124). Next, the administrator can edit the functional spreadsheet administrative meta data, i.e. spreadsheet name, access list and functional description. Next, program 30 displays the administrative data (step 128). Refer again to decision 118, no branch where the administrator does not opt to edit the spreadsheet administrative meta data. If the administrator opts to delete the functional spreadsheet (decision 120, yes branch), then program 30 deletes the spreadsheet administrative meta data 68 and also the functional spreadsheet 28′ from storage 56-1 (step 122). In the illustrated example, the administrator does not opt to delete the spreadsheet administrative meta data 68 or functional spreadsheet 28′.

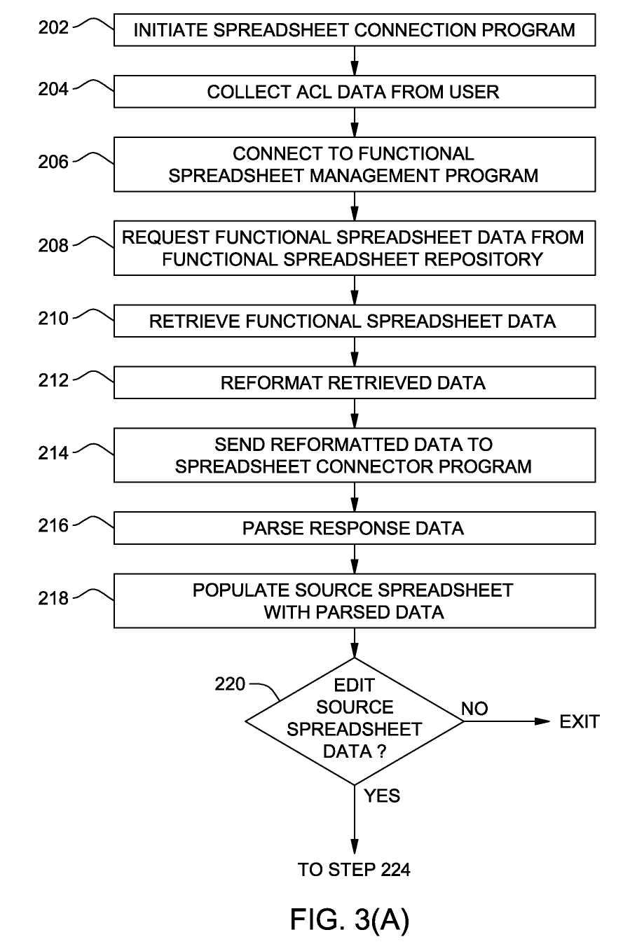

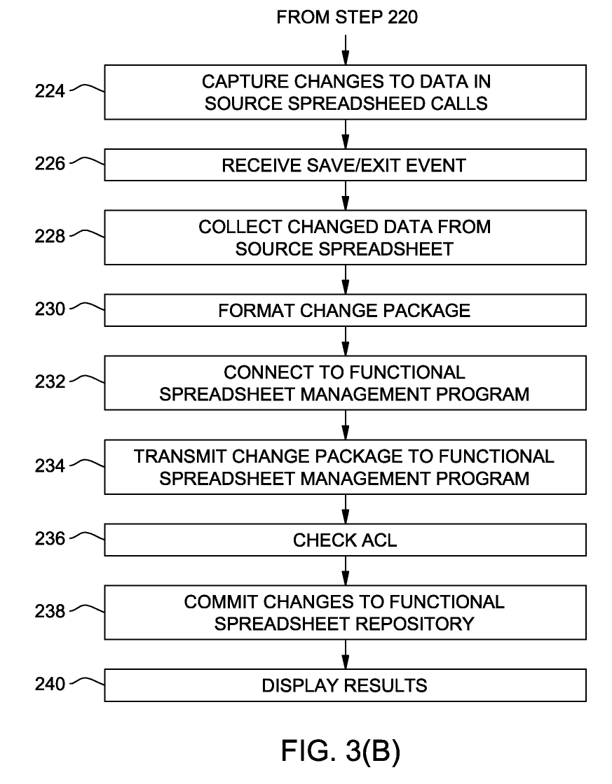

FIGS. 3(A) and 3(B) illustrates the use and operation of program 30 to access a functional spreadsheet 28′ from storage 56-1 and send the current version of the functional spreadsheet to client computer 20 for user update using spreadsheet generation program 27. In step 202, a user opens spreadsheet 28 from storage 27. Spreadsheet 28 includes a macro that was provided by spreadsheet management program 30 and embedded in spreadsheet 28 in step 110. The macro queries the user for UserID and password and checks whether this user is authorized to access spreadsheet 28 (step 204). Next, the macro in the spreadsheet 28 connects to program 30 using the access control information provided by the user (step 206). In response, program 30 requests and retrieves the functional spreadsheet 28′ from storage 56-1 (steps 208 and 210). In response, program 30 reformats the spreadsheet 28′ into XML format for transport back to the spreadsheet generation program 27 (step 212) and initiates response communication back to the spreadsheet connector program 29 (step 214). The spreadsheet generation program 27 receives and parses the functional spreadsheet 28′ data (step 216), and populates the cells of the source spreadsheet 28 from the corresponding cells of functional spreadsheet 28′ (step 218). Depending on the user's access privileges, a user may now view or edit the spreadsheet 28 in the normal manner provided by the spreadsheet generation program 27 (step 220). If the user has write privileges, the user may edit the spreadsheet 28 using the functions offered by the spreadsheet generation program 27, and the spreadsheet generation program 27 records the updates in storage 26 (step 224). After the user completes his or her updates and saves/exits the spreadsheet 28, (step 226), the spreadsheet connector program 29 captures the changes made by the user (step 228), and formats the changes into XML (as a change-package) (step 230). Next, the spreadsheet connector program initiates connection to the spreadsheet management program 30 (step 232) and then transmits the change package to the spreadsheet management program 30 along with the user's UserID and password (step 234). The spreadsheet management program 30 validates the user's privileges (step 236) and if the user is allowed to update the spreadsheet, copies/commits the changes to the spreadsheet 28′ in storage 56-1 and displays the status of that action (success/failure) to the user (step 240).

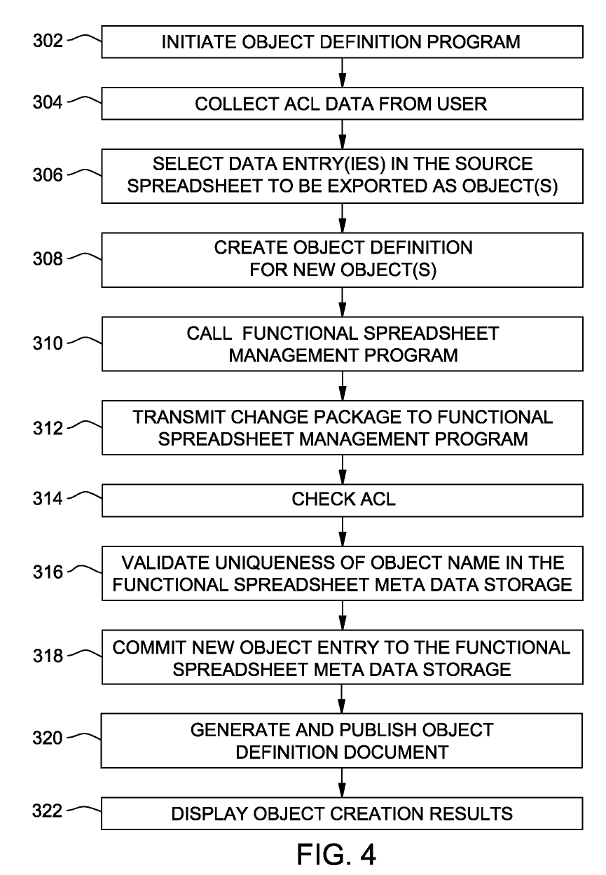

FIG. 4 illustrates operation and function of program 30 to specify which data entries should be made available to which other programs, by subsequent request from such other programs (subsequent “pulling”). To begin the process, the user initiates object definition program function 41 (step 302). In response, program 41 queries the user for access control credentials and compares the access control credentials to an Access Control List (step 304). Assuming the user is authorized to access spreadsheet 28, program 41 prompts the user to select and define cells or ranges of cells in the spreadsheet 28 whose data entries the user would like to make available to other programs (step 306). By way of example, the user can select such data entries by use of a mouse cursor. After selecting each cell, program 41 queries the user to define an “object” corresponding to the selected cell. To define the object, the user specifies a name of the object, names and data types for the selected cells, and public/private access rights to the newly defined object. Also, if any formulas are contained within the selected cells, the user may choose to expose them as callable methods of the object. In response, program 41 stores the user specified information about the object along with an identification of the cell (step 308). While the format of the object's description is not important to the present invention, the format can be Web Services Description Language (“WDSL”) or Data Definition Language (“DDL”). In response to user definition of the object, program 41 calls program 30 (step 310) and forwards the object definition along with the user's credentials to program 30 (step 312). In response, program 30 validates the user's privilege to send the object (step 314). Assuming the user is authorized to send the object, program 30 validates that the name of the new object is unique i.e. does not already exist in the spreadsheet object meta data storage 38 (step 316). If the name of the new object is unique, program 30 commits the new object definition to the spreadsheet object meta data storage 38 (step 318). For the case where the newly defined object will be published and “pulled” by other programs, program 30 generates a publishable object definition document (e.g. using a WSDL, DDL or other format) including the new object definition. Also, program 30 makes the object definition document publicly available via object communicator program 39 (step 320). If the user designated the new object definition as “publicly available”, then program 30 publishes the new object definition, for example, to a UDDI (Universal Description Discovery and Integration) server or Services Catalog, and makes the new object available by invocation. Program 30 formats the new object definition for transport over a network and also forwards the new object definition to administrative interface 37 for display to an administrator (step 322).

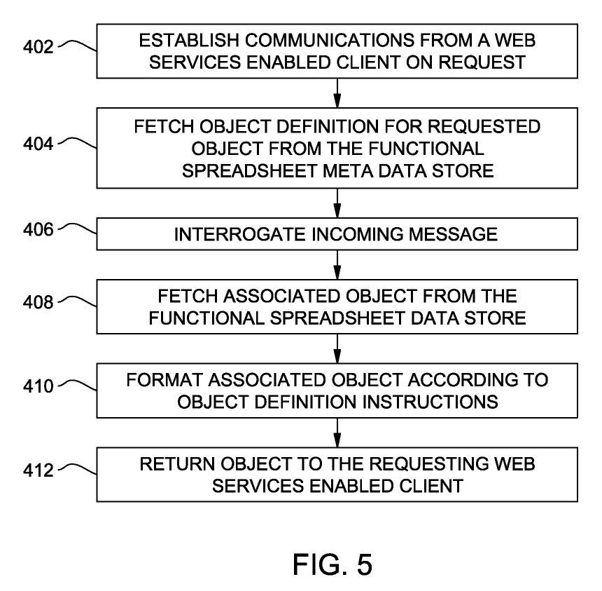

FIG. 5 illustrates operation and function of program 30 to furnish the published objects to other programs upon their request. These other programs can be application program or web service 45. When this other program requests the published object (including the data entry in the object), this is also called “pulling” the object/data entry. In the illustrated example, program 30 published the objects using a standard protocol such as SOAP, WSDL, XML, etc and the application program or web service program 45 uses the same protocol, i.e. SOAP, WSDL, XML etc. to view the published objects. Next, the application program or web service program initiates communication with the object communicator program 39 and requests a specified object definition of interest to the requesting program 45 (step 402). In response, the object communicator program 39 invokes program 30 to fetch the named object definition from the spreadsheet object meta data storage 56-2 (step 404). Then, the object communicator program 39 determines from credentials, requester address information and other information in the request if the requester is authorized to receive the requested object, and the format for the object (step 406). Using this information, program 30 fetches the requested object from the spreadsheet data storage 56-1 (step 408) and formats and packages the object according to the instructions in the request (step 410). Next, program 30, via the object communicator program 39, returns the object to the requesting program in the requested format (step 412).

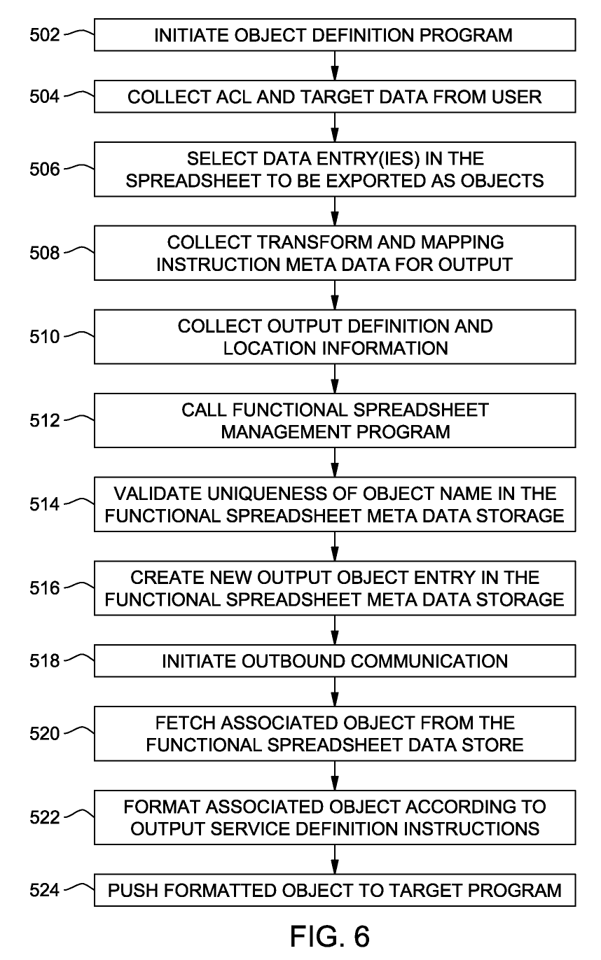

FIG. 6 illustrates operation and function of program 30 to “push” data entries to other programs, such as application program or web service program 45, periodically, when scheduled, when manually triggered by the user or when the data entry for the data object is updated in functional spreadsheet 28′. To manually trigger the “pushing” of the object, the user initiates object definition program function 41 (step 502). In response, program 41 collects access control credentials from the user and compares them to an access control list for functional spreadsheet 28′ (step 504). Next, program 41 prompts the user to select a cell or range of cells in the functional spreadsheet 28′ whose data entry(ies) the user would like to make available as an object and push to selected other programs (step 506). Next, program 41 prompts the user to define the object by specifying a name of the object, a target application program or web service program (such as program 45) that should receive the object by “pushing”, a function/address in the target program to receive the object, a cell in the spreadsheet whose data entry is embedded in the object. The user specifies the cell by selecting the cell with a mouse cursor. While the format of the object's description is not important to the present invention, the format can be WSDL or DDL. Because this newly defined data object will be “pushed” to the other program, and the object communicator program 39 will need to initiate outbound communication, program 41 prompts the user to enter information regarding mapping, i.e. to what function or address in the specified target application should the data entry be addressed, and a name, label, and data type for the corresponding data entry (step 508). Program 41 also prompts the user to enter outbound communication service information, for example, protocol bindings, destination IP or MAC address of the other program, etc. needed to communicate the data object to the other program (step 510). In response, program 41 invokes program 30 and furnishes the communication information and object definition (step 512). In response, program 30 determines if the name of the newly defined object is unique by querying the spreadsheet object meta data storage 38 (step 514), and if so, commits the newly formed object definition (step 516). Next, program 30, based on output communication instructions for “pushing” the object, initiates outbound communication to the destination program 45 via object communicator program 39 (step 518). Next, program 30 fetches the object from the spreadsheet data storage 56-1 (step 520), formats the data according to the object definition and output instructions (step 522), and pushes/sends the object to the other program (step 524).

Thus, the present invention exports (by “pushing” or “pulling”) selectable data entries from a spreadsheet as objects to an external program as defined in an object definition document.

Programs 27, 29 and 41 can be loaded into computer 20 from a computer readable media 80 such as magnetic tape or disk, optical media, DVD, semiconductor memory, memory stick, etc. or downloaded from the Internet via TCP/IP adapter card 82.

Programs 30, 37 and 39 can be loaded into server 50 from a computer readable media 70 such as magnetic tape or disk, optical media, DVD, semiconductor memory, memory stick, etc. or downloaded from the Internet via TCP/IP adapter card 72.

Based on the foregoing, a system, method and program for automatically exporting data entries from a spreadsheet to another program have been disclosed. However, numerous modifications and substitutions can be made without deviating from the scope of the present invention. For example, cells from one functional spreadsheet can be mapped to corresponding cells of another functional spreadsheet such that data entered into the cells of the one functional spreadsheet will automatically be entered into the corresponding cells of the other functional spreadsheet. This is implemented by defining a map which maps the cells in the one spreadsheet to the corresponding cells in the other spreadsheet. When a data entry is supplied to or updated in a mapped cell in the one spreadsheet, the data entry is automatically sent to the other spreadsheet to update the corresponding, mapped cell. The data entries in the cells of the other spreadsheet can then be pushed or pulled to other programs, in the same manner as described above for data entries in the cells of the one spreadsheet. Also, if desired, only a single copy of the spreadsheet is maintained, with all updates made to the single copy. In this embodiment, programs 27 and 41 are installed in server 50 (and program 29 is not needed), and the user generates the single copy of the spreadsheet using program 27 in server 50 for storage in storage 56-2, where it is accessible to programs 30, 37 and 39. In this embodiment, the user defines the objects using program 41 in server 50. Therefore, the present invention has been disclosed by way of illustration and not limitation and reference should be made to the following claims to determine the scope of the present invention.

What is claimed is:

1. A method for providing data to a program for processing, said method comprising the steps of:
mapping one or more cells in an electronic spreadsheet to the program; and
based on the mapping, automatically forwarding one or more data entries in said one or more cells, respectively, to said program for processing.

2. A method as set forth in claim 1 further comprising the step of receiving specification that said program should receive said one or more data entries, and wherein the step of forwarding said one or more data entries to said program is based in part on said specification.

3. A method as set forth in claim 2 further comprising the step of receiving specification of an address of said program, and wherein the step of forwarding said one or more data entries to said program is based in part on the address specification.

4. A method as set forth in claim 1 wherein said one or more data entries which are forwarded are forwarded in data objects.

5. A computer program product for providing data to a program for processing, said computer program product comprising:
a computer readable media;
first program instructions to map one or more cells in an electronic spreadsheet to the program; and
second program instructions, responsive to the mapping, to automatically forward one or more data entries in said one or more cells, respectively, to said program for processing; and wherein
said first and second program instructions are stored on said media in functional form.

6. A computer program product as set forth in claim 5 further comprising third program instructions to receive specification that said program should receive said one or more data entries, and wherein said second program instructions forward said one or more data entries to said program based in part on said specification; and said third program instructions are stored on said media in functional form.

7. A computer program product as set forth in claim 6 further comprising fourth program instructions to receive specification of an address of said program, and wherein said second program instructions forward said one or more data entries to said program based in part on the address specification; and said fourth program instructions are stored on said media in functional form.

8. A computer program product as set forth in claim 5 wherein said second program instructions forward said one or more data entries in one or more data objects, respectively.

9. A method for providing data to a program for processing, said method comprising the steps of:
publishing a list of data objects available for export, said data objects including respective data entries from respective cells in an electronic spreadsheet; and
in response to the program requesting one or more of said data objects, forwarding said one or more data objects to said program for processing.

10. A method as set forth in claim 9 further comprising the step of receiving specification of an address of said program, and wherein the step of forwarding said one or more data objects to said program is based in part on the address specification.
